(19) United States
(12) Patent Application Publication
(10) Pub. No.: US 2008/0056887 A1
(43) Pub. Date: Mar. 6, 2008

(54) HYDRAULIC GEAR MOTOR WITH INTEGRATED FILTER

(75) Inventors: Frank R. Iannizzaro, Austintown, OH (US); Lori A. Martinelli, Lordstown, OH (US); Joseph A. Kovach, Aurora, OH (US); Lisa K. Furches, Charlotte, NC (US)

Correspondence Address: RENNER, OTTO, BOISSELLE & SKLAR, LLP, Nineteenth Floor, 1621 Euclid Avenue, Cleveland, OH, 44115-2191, US

(73) Assignee: Entire Interest

(21) Appl. No.: 11/760,981

(22) Filed: Jun. 11, 2007

Related U.S. Application Data
(60) Provisional application No. 60/812,390, filed on Jun. 9, 2006.
(60) Provisional application No. 60/894,760, filed on Mar. 14, 2007.

(51) Int. Cl. F03B 11/08; F04B 49/00

(52) U.S. Cl. 415/121.2; 417/313; 417/310

(57) ABSTRACT

A cooling fan drive apparatus with an integrated filter comprises a gear motor contained within a housing that includes internal passages through which hydraulic fluid can flow and structure configured to receive a filter such that the filter forms an integral part of the apparatus.

### RELATED APPLICATION

This application claims the benefit of U.S. Provisional Application Nos. 60/812,390, filed Jun. 9, 2006, and 60/894,760, filed Mar. 14, 2007, which are hereby incorporated herein by reference in their entireties.

### FIELD OF THE INVENTION

The invention herein described relates generally to hydraulic drive systems for engine cooling fans and, more particularly, to a hydraulic gear motor with an integrated filter having particular application in mobile machinery such as, for example, skid steer and track loaders.

### BACKGROUND

Modern day internal combustion engines typically operate in a relatively narrow temperature range to meet prescribed emissions levels, yet off-highway engines often operate in a broad range of climates from desert heat to arctic cold. Along with basic engine cooling, a number of other cooling loads may also have to be dealt with, such as engine and hydraulic oil cooling, air conditioning refrigerant cooling, charge-air cooling, transmission cooling, etc. While the cooling loads are increasing, the available space in the engine compartment may be decreasing.

Hydraulic fan drive systems heretofore have been used as an alternative to traditional engine-mounted, belt-driven fans. Hydraulic fan drive systems have evolved over the last decade from relatively simple on/off systems into sophisticated, digitally controlled units. Perhaps the primary benefit of hydraulic cooling systems is their ability to control fan speed independent of engine speed, which allows the fan to be operated at the precise speed needed to accommodate the thermal load at any given part of the operating cycle.

Fan drive systems produced by Parker Hannifin Corporation for large and mid-size engines used in both on- and off-highway applications utilize a digital controller to monitor system conditions and adjust fan speed accordingly. At the heart of the system is a Parker controller in one of two basic configurations. Depending on application requirements, a high end controller may be used to communicate with other on-board systems via an industry standard J1939 communications bus and integrate multiple functions such as engine and transmission temperature control. Or a simpler model may be used to monitor inputs from temperature sensors in the various cooling loops and intelligently adjust fan speed as necessary to keep all systems within programmable limits.

Parker also offers other controllers, both digital and simple analog, designed to give users flexibility for retrofit or vehicle upgrades. Some of these can be directly connected to engine electronic control units and provide options including purge or fan reverse and visual diagnostics with data logging. These controllers are encapsulated in a flameproof epoxy block and ruggedized for mounting within the engine compartment or other exposed location.

Because fan operation is now fully programmable, a broad range of features intended to improve efficiency can be included. Examples are accelerated warm-up with the fan deactivated; “on delays,” which remove fan load during hot starts; and automated and/or on-demand purge or reverse airflow through the radiator to blow out dirt and debris.

The hydraulic components of these systems typically incorporate cast-iron gear, vane or piston pumps and motors. These components are noted for efficiency, durability, and high power density, which translates into small physical size. As a result, hydraulic systems are typically much smaller than conventional direct drive, pulley-driven and electrically driven fans. The fan and drive motor use very little space inside the engine compartment and can easily be mounted right on the radiator shroud. This is a significant advantage over direct-driven fans which typically require much more engine bay operating space and/or complicated belt and pulley mechanisms.

### SUMMARY OF THE INVENTION

The present invention provides a cooling fan drive apparatus with an integrated filter that affords one or more advantages heretofore not attainable by conventional hydraulic fan drive systems and components. The apparatus comprises a gear motor contained within a housing that includes internal passages through which hydraulic fluid can flow and structure configured to receive a filter such that the filter forms an integral part of the apparatus.

Accordingly, a drive apparatus comprises a housing having a fluid inlet and outlet for hydraulic fluid, an output shaft journalled in the housing for rotation, and at least one gear rotatable within the housing by hydraulic fluid flowing from the inlet to the outlet. The rotatable gear is operatively coupled to the output shaft such that rotation of the gear effects rotation of the output shaft. The housing includes a main body part having interior passages through which passes the hydraulic fluid flowing from the fluid inlet to the fluid outlet. The interior passages, then in series, open to a filter element interface at filter inlet and outlet openings, and a removable filter bowl is removably attached to the main body part and forms therewith a filter element chamber for housing a replaceable filter element.

In a preferred embodiment, the housing contains an anti-cavitation check valve in a flow passage connected between the fluid inlet and outlet. The flow passage may be at least in part formed by a bore that opens at one end to a side of the housing that enables the anti-cavitation check valve to be inserted into the housing through the bore.

In a preferred embodiment, filter bowl is threaded at an open end thereof for screwing onto a correspondingly threaded portion of the main body part.

In a preferred embodiment, a proportionally controlled relief valve is connected between the fluid inlet and outlet for controlling the flow of high pressure fluid acting to rotate the rotatable gear.

In a preferred embodiment, the main body part has a protruding nipple at the filter element interface, and the filter element includes a continuous ring of filter media separating an interior chamber within the filter element from an exterior chamber formed between the filter media and the bowl. The filter element has an opening at an inner axial end of the ring of filter media through which the nipple projects axially into the interior area, and one of the filter inlet and outlet openings communicates with the interior chamber and the other communicates with the exterior area.

A preferred filter element includes a filter media bypass valve that opens to allow flow of the hydraulic fluid from the filter inlet opening to the filter outlet opening without flowing through the filter media when the pressure difference across the filter media exceeds a prescribed amount. The bypass valve may be located interiorly of the ring of filter media at an axially outer end of the filter element, and the opening at the inner axial end of the ring of filter media may be formed in an end cap bonded to an end of the ring of filter media.

The end cap may have a peripheral flange portion that is held against the main body part by an end cap of the bowl when the bowl is attached to the main body part.

The drive apparatus may further comprise a pressure sensing device mounted to the housing for sensing the pressure difference across the filter media and for outputting a signal related to the pressure difference. The signal may be output only when the pressure difference exceeds a prescribed level.

The drive apparatus may be a gear motor including a pair of meshed gears. The gears may be supported on respective gear shafts journalled between the main body part and a second body part fastened to the main body part. The output shaft may be unitary with one of the gear shafts.

The drive apparatus is particularly suited for driving a cooling fan of internal combustion engine, in which case the cooling fan may be mounted to the output shaft for rotation therewith.

The foregoing and other features of the invention are hereinafter more fully described and particularly pointed out in the claims, the following description setting forth in detail certain illustrative embodiments of the invention, these being indicative, however, of but a few of the various ways in which the principles of the invention may be employed.

### BRIEF DESCRIPTION OF THE DRAWINGS

In the annexed drawings:

FIG. 1 is a side elevational view of an exemplary drive apparatus according to the invention, specifically a hydraulic gear motor with an integrated filter;

FIG. 2 is a side elevational view of the drive assembly, looking from a direction opposite that of FIG. 1;

FIG. 3 is a top plan view of the drive assembly, looking from the line 3-3 of FIG. 1;

FIG. 4 is a side elevational view of the drive assembly, looking from the line 4-4 of FIG. 2;

FIG. 5 is a cross-sectional view of the drive assembly, taken along the line 5-5 of FIG. 3;

FIG. 6 is a side elevational view, partly broken away in section, of the drive assembly, looking from the line 6-6 of FIG. 3; and

FIG. 7 is a hydraulic schematic of the drive assembly.

### DETAILED DESCRIPTION

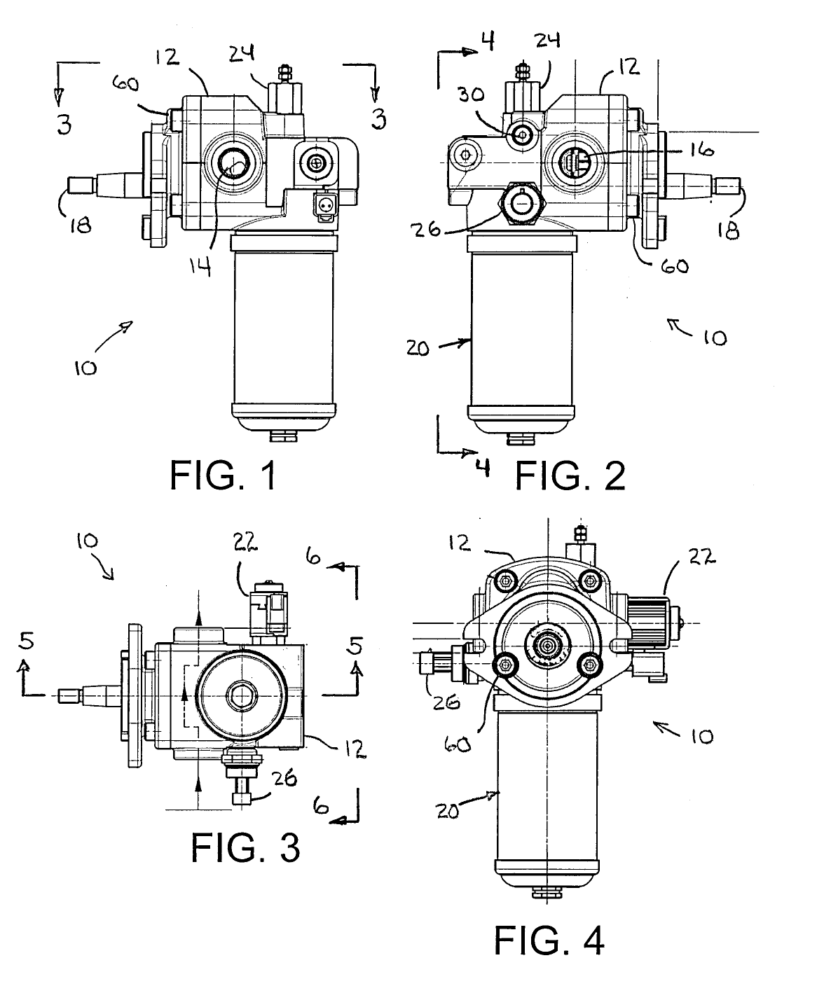

Referring now in detail to the drawings, and initially to FIGS. 1-4, an exemplary drive apparatus, specifically a hydraulic gear motor apparatus with an integrated filter according to the invention, is indicated generally at 10. The gear motor apparatus 10 has particular use for driving a cooling fan, such as a cooling fan used in an internal combustion engine to provide primary and/or secondary cooling. For example, the gear motor apparatus 10 may be used in place of the cooling fan motor, filter, and fan control described in U.S. Pat. No. 6,463,893, which patent is hereby incorporated herein by reference. In such cooling fan drive system, the filtered hydraulic fluid outputted by the herein described fan motor can be supplied to the charge pump or to the hydraulic tank.

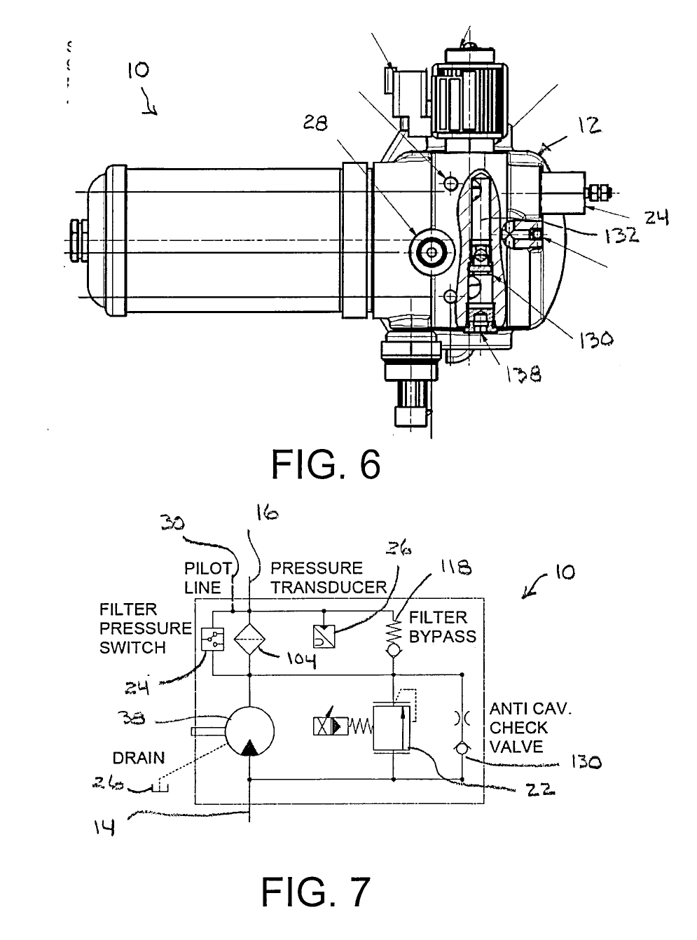

The gear motor apparatus 10 comprises a housing 12 having a fluid inlet 16 and a fluid outlet 14 for hydraulic fluid, an output shaft 18 journalled in the housing for rotation, spin-on filter bowl 20, a proportional relief valve 22, a filter pressure switch 24 and a pressure transducer 26. The housing also has a drain port 28 (FIG. 6) and a pilot port 30 which are discussed below in connection with the hydraulic schematic of FIG. 7.

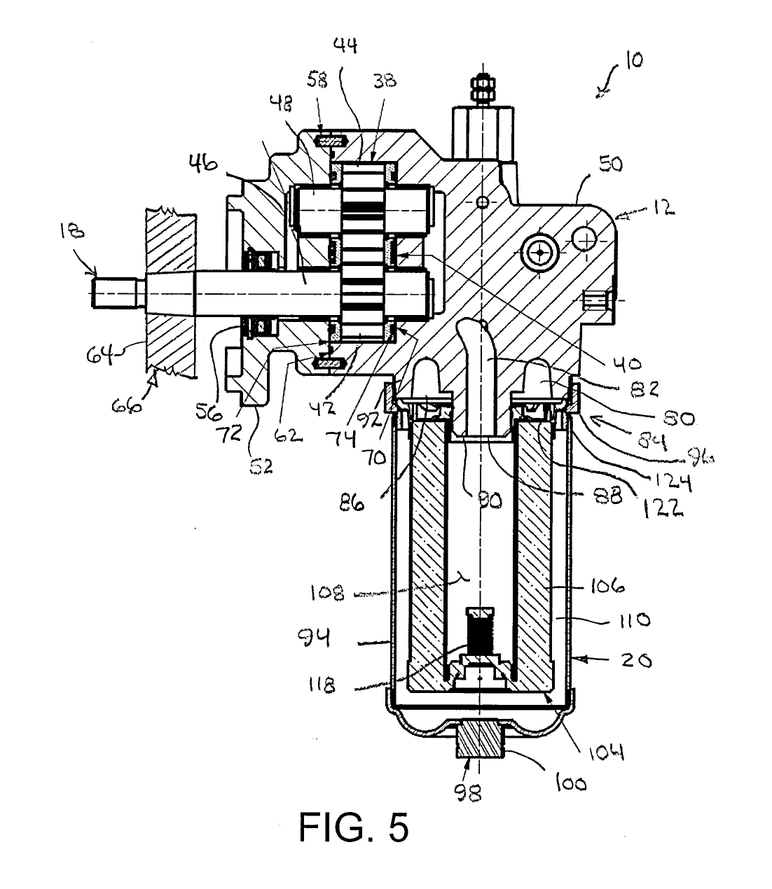

Referring now to FIG. 5, a gear motor 38 includes one or more gears are rotatable within a gear chamber 40 in the housing 12 by hydraulic fluid flowing from the fluid inlet to the fluid outlet. In the illustrated embodiment, a pair of meshed gears 42 and 44 are supported on respective gear shafts 46 and 48 journalled between a main body part 50 and a second body part 52 fastened to the main body part. Although other configurations may be used to operatively couple the gears to the output shaft 18, the illustrated output shaft is unitary with the gear shaft 46. Suitable bearings, such as bushings, are provided for the shafts, and the output shaft may be surrounded by a lip seal 56 that prevents leakage of hydraulic fluid along the output shaft. Dowel pins 58 are provided properly to locate the second body part on the main body part, and suitable fasteners 60 (FIGS. 1 and 4) are provided for securing the second body part to the main body part with a gasket 62 interposed between mating sealing surfaces of the second and main body parts. As shown, the hub 64 of a cooling fan 66 may be mounted to output shaft for rotation therewith.

The main body part 50 has interior passages through which passes the hydraulic fluid flowing from the fluid inlet to the fluid outlet. The interior passages supply and take away fluid from port plates 70 and 72 between which the gears 42 and 44 are sandwiched in a conventional manner. The configuration of the port plates, as well as the gears, may be conventional and thus the details thereof need not be described. The port plates may be sealed to the housing in a conventional manner, as by gaskets 74.

In regard to the present invention, the flow path from the fluid inlet to the fluid outlet includes interior passages 80 and 82 that open to a filter element interface 84 at filter inlet and outlet openings 86 and 88. In the illustrated embodiment, the opening 88 is provided at the end of a protruding nipple 90, while the other opening 86 is formed by an annular groove in an annular surface surrounding the nipple 90. The annular surface is provided on the end face of a short cylindrical projection 92 of the main body part that is externally threaded for mating with an internally threaded end portion of the screw-on filter bowl 20. As shown, the filter bowl may include a thin wall cylinder 94 to which an internally threaded ring 96 is secured as by welding, bonding, etc. The other end of the cylinder is closed by a dome 98 that may have a central wrenching head 100 to facilitate tightening of the bowl to the main body part of the housing.

The bowl 20 surrounds a filter element 104 that preferably is replaceable. The filter element 104 may include a continuous ring 106 of filter media separating an interior chamber 108 within the filter element from an exterior chamber 110 formed between the filter media and the bowl. The filter element has an opening at an inner axial end of the ring of filter media through which the nipple 90 projects axially into the interior area, and the filter inlet and outlet openings 86 and 88 respectively communicate with the exterior and interior chambers 110 and 108. If desired, the flow passages can alternatively be arranged such that the direction of flow through the filter element is from inside to outside.

A preferred filter element 104 includes a filter media bypass valve 118 that opens to allow flow of the hydraulic fluid from the filter inlet opening 86 to the filter outlet opening 88 without flowing through the filter media 106 when the pressure difference across the bypass valve, and thus across the filter media, exceeds a prescribed amount. The bypass valve may be located interiorly of the ring of filter media at an axially outer end of the filter element.

The nipple receiving opening at the inner axial end of the ring of filter media may be formed in an end cap 122 bonded to an end of the ring 106 of filter media. The end cap may have a peripheral flange portion 124 that is held against the main body part by the bowl when the bowl is attached to the main body part. The peripheral flange portion may be provided with one or more apertures to enable flow of hydraulic fluid from the passage 80 to the chamber 110. When assembled, the longitudinal axis of the filter element is perpendicular to the axis of the output shaft.

Referring now to FIG. 6, the housing 12 contains an anti-cavitation check valve 130 in a flow passage 132 connected between the fluid inlet and outlet. The flow passage may be at least in part formed by a bore that opens at one end to a side of the housing that enables the anti-cavitation check valve to be inserted into the housing through the bore. After insertion of the anti-cavitation valve, the opening is closed by a plug 138.

The operational relationship of the components of the gear motor apparatus 10 is schematically illustrated in FIG. 5. High pressure hydraulic fluid, such as may be supplied by a pump in the hydraulic system of a vehicle, is supplied to the fluid inlet 16 for rotating the meshed gears of the gear motor 38 and discharged to the fluid outlet 14. The flow of the high pressure fluid acting to rotate the rotatable gears is controlled by the proportionally controlled relief valve 22 connected between the fluid inlet and outlets in parallel with the gear pump. The proportionally controlled relief valve may be of a conventional type and conventionally controlled to vary the flow to the gear pump and thus the rotational speed of the cooling fan. Leakage from the gear pump is drained via the drain port 26.

The anti-cavitation check valve 130 is also connected between the fluid inlet and outlets in parallel with the gear pump. The anti-cavitation check valve prevents gear motor damage when the pump supply is cut-off as momentum continues to spin the cooling fan.

The integrated filter pressure switch 118 is connected across the filter inlet and outlet and thus is responsive to the pressure difference across the filter media. If the pressure difference exceeds a prescribed amount, a signal is output to indicate that the filter has become clogged by a corresponding amount. The signal can be used to control an indicator light on the vehicle's control panel or elsewhere to indicate that the filter element needs servicing.

The differential pressure setting of the filter pressure switch 24 should be set lower than that of the filter bypass valve 118. When the differential pressure exceeds the threshold of the filter bypass valve, hydraulic flow is allowed to bypass the filter media to prevent the differential pressure from reaching a level that would collapse the filter media. Before that point is reached, the filter pressure switch should already have been indicating a need to change the filter element so as to avoid a bypass flow condition from occurring. This would ensure that the hydraulic fluid exiting through the fluid outlet is filtered.

The integrated pressure transducer 26 is provided to monitor the pressure at the fluid outlet. The transducer can be used to supply a charge pressure signal to the vehicle/machine controller for diagnostics.

Those skilled in the art will now appreciate the foregoing gear motor apparatus can afford various advantages. While providing infinite variable fan speed control and anti-cavitation prevention, system part count, cost, system losses and leak paths are reduced when compared to conventional systems. Although the invention has been shown and described with respect to a certain embodiment or embodiments, it is obvious that equivalent alterations and modifications will occur to others skilled in the art upon the reading and understanding of this specification and the annexed drawings. In regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A drive apparatus comprising a housing having a fluid inlet and outlet for hydraulic fluid; an output shaft journalled in said housing for rotation; and at least one gear rotatable within the housing by hydraulic fluid flowing from the inlet to the outlet, the rotatable gear being operatively coupled to the output shaft such that rotation of the rotatable gear effects rotation of the output shaft; and the housing including a main body part having interior passages through which passes the hydraulic fluid flowing from the fluid inlet to the fluid outlet, said interior passages opening to a filter element interface at filter inlet and outlet openings, and a removable filter bowl removably attached to the main body part and forming therewith a filter element chamber for housing a replaceable filter element.

2. A drive apparatus as set forth in claim 1, wherein the housing contains an anti-cavitation check valve in a flow passage connected between the fluid inlet and outlet.

3. A drive apparatus as set forth in claim 2, wherein the flow passage is at least in part formed by a bore that opens at one end to a side of the housing that enables the anti-cavitation check valve to be inserted into the housing through the bore.

4. A drive apparatus as set forth in claim 1, wherein the filter bowl is threaded at an open end thereof for screwing onto a correspondingly threaded portion of the main body part.

5. A drive apparatus as set forth in claim 1, further comprising a proportionally controlled relief valve connected between the fluid inlet and outlet for controlling the flow of high pressure fluid acting to rotate the rotatable gear.

6. A drive apparatus as set forth in claim 1, further comprising the replaceable filter element.

7. A drive apparatus as set forth in claim 6, wherein the main body part has a protruding nipple at the filter element interface; and the filter element includes a continuous ring of filter media separating an interior chamber within the filter element from an exterior chamber formed between the filter media and the bowl, and an opening at an inner axial end of the ring of filter media through which the nipple projects axially into the interior area, and one of the filter inlet and outlet openings communicates with the interior chamber and the other communicates with the exterior area.

8. A drive apparatus as set forth in claim 7, wherein the filter element further includes a filter media bypass valve that opens to allow flow of the hydraulic fluid from the filter inlet opening to the filter outlet opening without flowing through the filter media when the pressure difference across the filter media exceeds a prescribed amount.

9. A drive apparatus as set forth in claim 8, wherein the bypass valve is located interiorly of the ring of filter media at an axially outer end of the filter element.

10. A drive apparatus as set forth in claim 9, wherein the opening at the inner axial end of the ring of filter media is formed in an end cap bonded to an end of the ring of filter media.

11. A drive apparatus as set forth in claim 10, wherein the end cap has a peripheral flange portion that is held against the main body part by the bowl when the bowl is attached to the main body part.

12. A drive apparatus as set forth in claim 1, further comprising a pressure sensing device mounted to the housing for sensing the pressure difference across the filter media and for outputting a signal related to the pressure difference.

13. A drive apparatus as set forth in claim 12, wherein the signal is output only when the pressure difference exceeds a prescribed level.

14. A drive apparatus as set forth in claim 1, wherein the at least one gear includes a pair of meshed gears supported on respective gear shafts journalled between the main body part and a second body part fastened to the main body part, and the output shaft is unitary with one of the gear shafts.

15. A drive apparatus as set forth in claim 1, further comprising a cooling fan mounted to the output shaft for rotation therewith.

16. A drive apparatus as set forth in claim 1, wherein the filter element has a longitudinal axis perpendicular to the axis of the output shaft.

17. A hydraulic apparatus comprising:
a gear motor;
a housing in which the gear motor is located, the housing including internal passages through which hydraulic fluid may flow and having structure adapted to receive a filter so that the filter becomes an integral portion of the housing.

18. A filter element for use in a hydraulic drive apparatus, comprising a continuous ring of filter media surrounding an interior chamber within the filter element, an opening at an inner axial end of the ring of filter media, a filter media bypass valve that opens to allow flow of the hydraulic fluid between the interior chamber and exterior of the filter media when the pressure difference across the bypass valve exceeds a prescribed amount.
